(19) United States
(12) Patent Application Publication
(10) Pub. No.: US 2026/0294176 A1
(43) Pub. Date: Oct. 1, 2026

(54) Cutting Board Flipper

(71) Applicant: Paul Micheal Ptaszynski, Peoria, AZ (US)

(72) Inventor: Paul Micheal Ptaszynski, Peoria, AZ (US)

(21) Appl. No.: 19/563,925

(22) Filed: Mar. 11, 2026

Related U.S. Application Data
(60) Provisional application No. 63/779,946, filed on Mar. 28, 2025.

(51) Int. Cl. A47J 47/00; A47J 47/16

(52) U.S. Cl. CPC A47J 47/005; A47J 47/16

(57) ABSTRACT

A cutting board flipper device comprising a C-shaped metal rod fabricated from stainless steel, aluminum, or corrosion-resistant alloys, pivotally mounted upon a plastic pivot rod constructed from engineering-grade polymers such as polypropylene or nylon. The plastic pivot rod is secured within pre-drilled apertures on opposing sides of a wooden cutting board via epoxy-based adhesive. The flipping mechanism enables pivotal movement of the cutting board to either side, elevating the board from the workspace surface to minimize moisture accumulation and inhibit bacterial proliferation.

### FIELD OF THE INVENTION

The present invention generally relates to kitchen tools. More specifically, the present invention relates to an innovative cutting board with an integrated flipper mechanism designed to improve stability and hygiene during food preparation.

### BACKGROUND OF THE INVENTION

Cutting boards are fundamental kitchen tools used in food preparation for chopping, slicing, and dicing food items. Conventional cutting boards, however, suffer from well-known limitations that adversely affect their functionality and hygienic properties. A primary deficiency of traditional cutting boards is the lack of effective mechanisms to maintain stability while preventing moisture accumulation beneath the board surface when in contact with a countertop or workspace.

Moisture buildup beneath a stationary cutting board creates significant problems, including material warping, splitting, and promoting bacterial proliferation. These moisture-related issues pose health risks and compromise food safety during food preparation activities. Research has established that inadequate drying practices and insufficient ventilation beneath cutting boards accelerate material degradation, resulting in premature failure and requiring frequent board replacement.

Additionally, conventional cutting boards often lack features that facilitate efficient access to both cutting surfaces. While some traditional designs incorporate rubber feet to enhance stability, such features effectively prevent users from flipping the board to access the opposite clean surface. This limitation restricts efficient utilization of both board surfaces, complicates the food preparation process, and may discourage proper cleaning practices. As a result, food debris accumulates on the cutting surface, thereby compromising sanitation and food safety standards.

Prior art solutions have attempted to address some of these issues. However, existing devices suffer from limitations including excessive complexity, enlarged form factors, or difficulty in practical use. Accordingly, there exists a need for an improved cutting board assembly that incorporates an integrated flipper mechanism capable of enabling users to easily flip and pivot the cutting board to utilize both surfaces while maintaining a stable and secure platform. Furthermore, an effective solution must elevate the cutting board above the workspace surface to minimize moisture contact and prevent bacterial proliferation resulting from stagnant moisture accumulation. Such an invention would significantly enhance food safety, improve operational efficiency in kitchen environments, and extend the operational lifespan of cutting boards.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention relates to a cutting board flipper assembly that enhances the functionality and hygienic properties of conventional cutting boards through an integrated pivoting mechanism. The assembly comprises a C-shaped metal rod and a plastic pivot rod configured to work in concert to enable controlled pivotal movement of the cutting board.

The C-shaped metal rod, fabricated from stainless steel, aluminum, or corrosion-resistant alloys, is substantially elongated and shaped in a distinct “C” configuration to function as a lever arm. The plastic pivot rod, constructed from engineering-grade polymers such as polypropylene or nylon, serves as the pivotal axis about which the C-shaped metal rod rotates.

The plastic pivot rod is disposed through pre-drilled apertures positioned on opposing sides of the wooden cutting board and is secured within these apertures via an epoxy-based adhesive, establishing a permanent and durable bond.

The flipping mechanism operates by allowing the C-shaped metal rod to pivot in either direction relative to the cutting board, enabling users to lift and flip the board to access both cutting surfaces. This pivotal action elevates the cutting board above the workspace surface, thereby minimizing direct contact between the board's underside and the counter, which prevents moisture accumulation beneath the board. By preventing moisture retention and stagnant water conditions, the assembly effectively inhibits bacterial proliferation and reduces the risk of material degradation resulting from prolonged moisture exposure.

The structure provides enhanced stability and resistance to sliding during food preparation activities. The integrated design eliminates the need for separate stabilizing devices while simultaneously enabling efficient access to both surfaces of the cutting board. This dual functionality addresses multiple deficiencies of conventional cutting boards while maintaining a compact and practical form factor suitable for standard kitchen environments.

### BRIEF DESCRIPTION OF THE DRAWINGS

FIG. 1 shows an embodiment of the present invention.

FIG. 2 shows the embodiment of FIG. 1 during installation of a flipper.

FIG. 3 shows a flipper with sleeves.

FIG. 4 shows an alternative embodiment of the present invention with a flipper.

FIG. 5 illustrates the present invention positioned on a workspace.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application in culinary tool design and function. As should be understood, any embodiment may incorporate only one or a plurality of the above-disclosed aspects of the disclosure and may further integrate only one or a plurality of the aforementioned features such as the C-shaped metal rod, plastic pivot rod, and epoxy adhesive utilized in the cutting board flipper assembly. Furthermore, any embodiment discussed and identified as being “preferred” is considered to be part of a best mode contemplated for carrying out the embodiments of the present disclosure. Other embodiments may also be presented for additional illustrative purposes in facilitating a comprehensive and enabling disclosure. Moreover, numerous embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments of a cutting board flipper that enhances stability and hygiene during food preparation, it is to be understood that this disclosure is illustrative and exemplary of the present disclosure and is intended merely to provide a full and enabling disclosure. The detailed description herein of one or more embodiments is not intended, nor is it to be construed, as limiting the scope of patent protection afforded in any claim of a patent issuing herefrom, which scope is to be defined by the claims and the equivalents thereof. It is not intended that the scope of patent protection be defined by reading into any claim limitation found herein and/or issuing herefrom that does not explicitly appear in the claim itself.

Thus, for example, any sequence(s) and/or temporal order of steps of various processes or methods related to the assembly and operation of the cutting board flipper described herein are illustrative and not restrictive. Accordingly, it should be understood that, although steps of various processes or methods may be shown and described as being in a specific sequence or temporal order, the steps of any such processes or methods are not limited to being executed in any particular sequence or order, absent an indication otherwise. Indeed, the steps in such processes or methods may generally be performed in various sequences and orders while still falling within the scope of the present disclosure. Therefore, it is intended that the scope of patent protection is defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is pertinent to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items. Finally, when used herein to join a list of items, “and” denotes “all of the items of the list.”

The following detailed description refers to the accompanying drawings. Wherever possible, the same reference numbers are used in the drawings and the subsequent description to refer to the same or similar elements. While many embodiments of the disclosure may be described, modifications, adaptations, and other implementations are possible. For example, substitutions, additions, or modifications may be made to the elements illustrated in the drawings, and the methods described herein may be enhanced by substituting, reordering, or adding stages to the disclosed methods. Accordingly, the following detailed description does not limit the disclosure. Instead, the proper scope of the disclosure is defined by the claims found herein and/or issuing herefrom. The present disclosure contains headers. It should be understood that these headers are used as references and are not to be construed as limiting upon the subject matter disclosed under each header.

The present disclosure includes many aspects and features. Moreover, while many aspects and features relate to, and are described in the context of methods, systems, apparatuses, and devices for enhancing the functionality and hygiene of culinary instruments such as cutting boards through innovative flipper mechanisms, embodiments of the present disclosure are not limited to use only in this context.

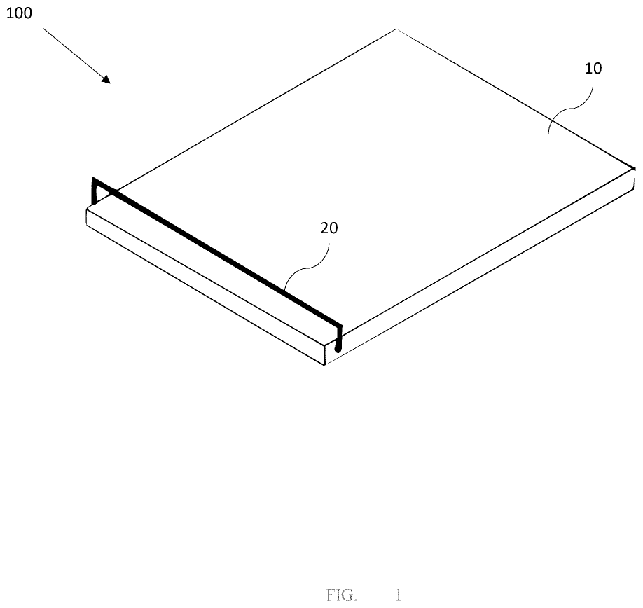

The present invention, as shown in FIGS. 1-5, pertains to an innovative assembly 100 for a cutting board flipper that enhances the stability and hygienic properties associated with conventional cutting boards.

Through meticulous engineering of each component's design and operational functionality, the present invention offers a robust solution for food preparation, ensuring that the cutting board remains leveled and securely positioned, while simultaneously mitigating moisture accumulation.

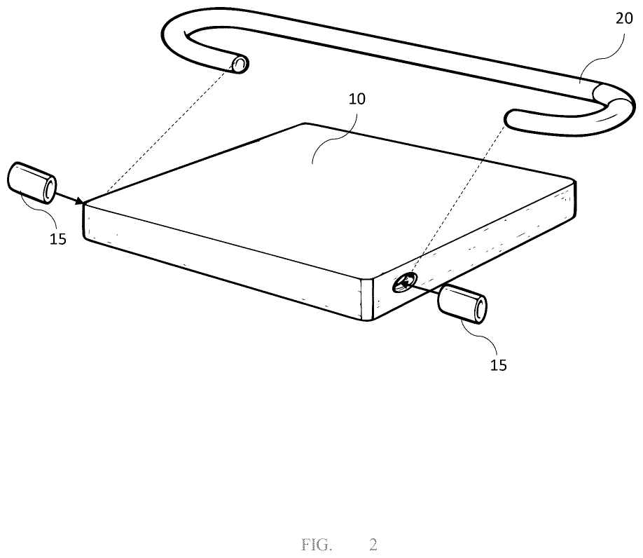

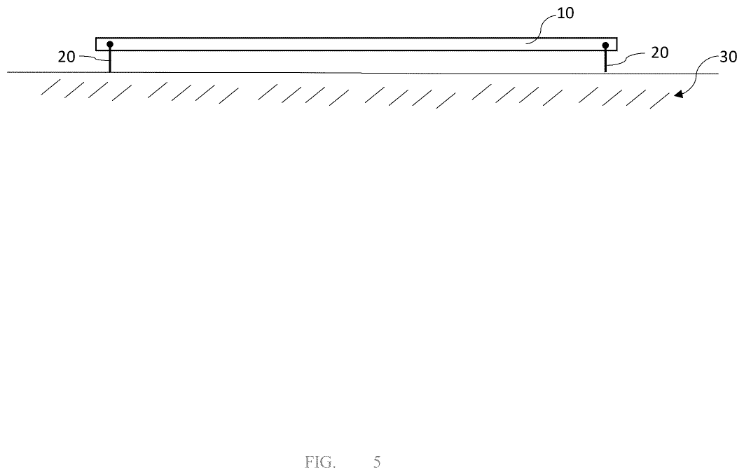

In preferred embodiment, as shown in FIG. 1, FIG. 2 and FIG. 5, the present invention 100 provides a device comprising a cutting board 10 having a flipping mechanism.

### Cutting Board

The cutting board 10 may comprise any cutting board recognized in the art, including, but not limited to, wooden cutting boards and analogous types of cutting boards. The cutting board 10 may be formed with grooves and holes, including at least one juice groove configured to channel liquids. The cutting board 10 may be formed with non-slip features, including rubber pads or elastomeric inserts, positioned to prevent inadvertent movement during use.

### Flipping Mechanism

The flipping mechanism may include the following components:

### C-shaped Metal Rod

The primary component of the flipper assembly is a metal rod 20 (in one embodiment, with a diameter of ⅛ inch, shaped into a distinct “C” configuration).

This structural design imparts both flexibility and mechanical strength, enabling the rod 20 to operate effectively as a lever for the flipping mechanism. The rod 20 may be fabricated from a selection of materials including, but not limited to, stainless steel, aluminum, or other corrosion-resistant alloys, providing durability and facilitating a hygienic cleaning process. The open end of the “C” may function as a lever arm, facilitating an efficient flipping motion.

In one embodiment, the C-shaped metal rod 20 can be configured to pass through a smaller, robust plastic rod, which serves as the pivotal axis for the flipper mechanism.

In lieu of metallic construction, the rod 20 may also be produced from high-strength thermoplastic or composite materials or any other similar materials, offering additional advantages such as reduced weight and enhanced resistance to corrosion.

### Plastic Pivot Rod

This component comprises a smaller plastic rod 15 that acts as a hinge about which the C-shaped metal rod 20 rotates. It is critical in permitting a seamless and smooth flipping action while maintaining an overall compact assembly. In some embodiments, the plastic pivot rod 15 can be constructed from engineering-grade polymers such as polypropylene or nylon, which are selected for their wear resistance and operational longevity.

The plastic pivot rod 15 can be adapted for insertion through pre-drilled apertures on opposing sides of the cutting board 10.

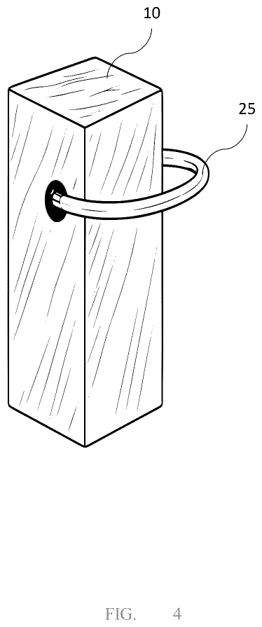

Various configurations regarding the shape or dimensions of the pivot rod 15 may be employed based on the specific geometries of the cutting board 10. The plastic pivot rod 15 may be a hollow cylindrical rod. Additionally, the pivot rod 15 may be designed using a flexible material that can accommodate variations in cutting board thickness, as shown in FIG. 4.

### Epoxy Adhesive

An epoxy-based adhesive is employed to securely affix the plastic pivot rod within the drilled apertures of the cutting board. This adhesive provides a strong and durable bond, ensuring that the integrity of the assembly is preserved and preventing any movement during operational use.

The epoxy establishes a permanent bond between the plastic pivot rod and the cutting board substrate, thereby ensuring the functional reliability of the pivot action of the C-shaped metal rod 20.

In some embodiments, other adhesive compounds, such as polyurethane adhesives or specialized food-safe adhesives, may be utilized to meet specific safety and compatibility requirements of various materials.

The design of the metal flipper (C-shaped metal rod) 20 of the present invention allows it to pivot to either side of the cutting board 10, thereby providing essential operational versatility for effective food preparation. As shown in FIG. 5, this assembly is engineered to elevate the cutting board 10 from the workspace surface 30, thereby minimizing contact with moisture and inhibiting bacterial proliferation resulting from stagnant moisture.

The pivoting functionality of the metal rod 20 is contingent upon the integrity of the plastic pivot rod 15 affixed within the cutting board 10, ensuring that the board 10 remains stable and secure throughout its use.

In some embodiments, the present invention may include an alternative flipping mechanism that may incorporate a spring-loaded hinge system, which facilitates automatic return of the cutting board 10 to a flat orientation, further enhancing the usability of the assembly.

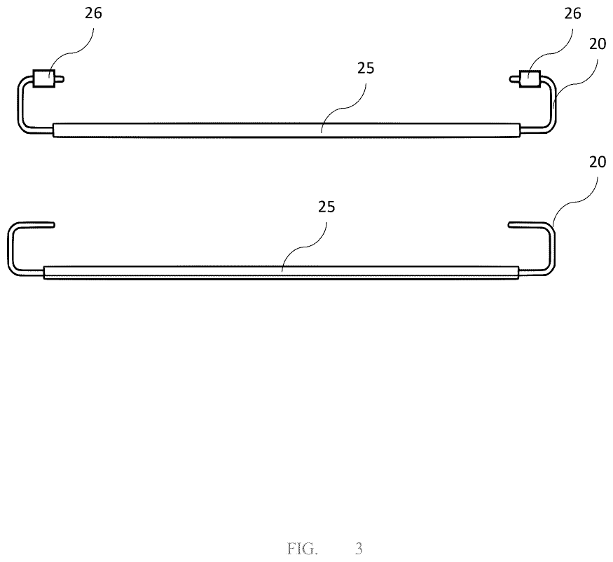

In certain embodiments, as illustrated in FIG. 3, the present invention may include one or more silicon sleeves 25, 26 and, may further comprise two or more flippers per board, with at least one flipper disposed on each side of the board.

Although the invention has been explained in relation to its preferred embodiment, it is to be understood that many other possible modifications and variations can be made without departing from the spirit and scope of the invention.

What is claimed is:

1. A device for enhancing the functionality and hygiene of a cutting board, comprising:
a cutting board; and
a flipping mechanism fixedly attached to the cutting board, the flipping mechanism comprising:
a C-shaped metal rod; and
a plastic pivot rod; wherein the C-shaped metal rod is pivotally mounted upon the plastic pivot rod, enabling the cutting board to pivot relative to a workspace surface to minimize moisture accumulation and inhibit bacterial proliferation.

2. The device of claim 1, wherein the cutting board comprises a wooden cutting board.

3. The device of claim 1, wherein the C-shaped metal rod is fabricated from a material selected from the group consisting of stainless steel, aluminum, and corrosion-resistant alloys.

4. The device of claim 1, wherein the C-shaped metal rod is fabricated from high-strength thermoplastic or composite materials, wherein the C-shaped metal rod includes one or more sleeves.

5. The device of claim 1, wherein the plastic pivot rod is constructed from engineering-grade polymers selected from the group consisting of polypropylene and nylon.

6. The device of claim 1, wherein the plastic pivot rod is adapted for insertion through pre-drilled apertures on opposing sides of the cutting board.

7. The device of claim 1, wherein the plastic pivot rod is fabricated from a flexible material configured to accommodate variations in cutting board thickness.

8. The device of claim 1, wherein the plastic pivot rod is secured within drilled apertures of the cutting board via an epoxy-based adhesive.

9. The device of claim 8, wherein the epoxy-based adhesive is selected from the group consisting of epoxy-based adhesive, polyurethane adhesives, and food-safe adhesives.

10. The device of claim 1, wherein the C-shaped metal rod is positioned at an end of the cutting board and provides a pivot point, permitting the cutting board to rotate about the pivot point, with the C-shaped metal rod being disposed symmetrically on opposing ends of the cutting board.

11. A flipping mechanism for use with a cutting board, comprising:
a C-shaped metal rod having one or more sleeves and configured to pivot;
a plastic pivot rod functioning as a pivot axis for the C-shaped metal rod, wherein the plastic pivot rod is a hollow cylindrical rod;
one or more pre-drilled apertures for securing the plastic pivot rod; and
an epoxy-based adhesive securing the plastic pivot rod within the pre-drilled apertures; wherein the C-shaped metal rod is pivotally mounted upon the plastic pivot rod to enable pivotal movement of a cutting board assembly and minimize moisture accumulation.

12. The flipping mechanism of claim 11, wherein the C-shaped metal rod has a diameter of approximately ⅛ inch.

13. The flipping mechanism of claim 11, wherein the C-shaped metal rod is fabricated from stainless steel or aluminum.

14. The flipping mechanism of claim 11, wherein the plastic pivot rod is constructed from engineering-grade polypropylene or nylon.

15. The flipping mechanism of claim 11, wherein the plastic pivot rod is flexible to accommodate variations in cutting board thickness.

16. The flipping mechanism of claim 11, wherein the epoxy-based adhesive is employed to provide a strong and durable bond ensuring the integrity of the cutting board assembly and preventing movement during operational use.

17. A cutting board assembly, comprising:
a wooden cutting board having pre-drilled apertures on opposing sides;
a C-shaped metal rod having a diameter of approximately ⅛ inch and fabricated from stainless steel or aluminum;
a plastic pivot rod constructed from engineering-grade polypropylene or nylon;
an epoxy-based adhesive securing the plastic pivot rod within the pre-drilled apertures; and
wherein the C-shaped metal rod is pivotally mounted upon the plastic pivot rod to enable pivotal movement of the cutting board assembly and minimize moisture accumulation on a work surface by elevating the wooden cutting board from the workspace surface.

18. The cutting board assembly of claim 17, wherein the cutting board comprises a juice groove surrounding its perimeter.

19. The cutting board assembly of claim 17, wherein the assembly includes non-slip features and one or more sleeves to prevent board movement during operational use.

20. The cutting board assembly of claim 17, wherein the cutting board is manufactured from bamboo or other analogous wood-type material.
